(19) United States
(12) Patent Application Publication
(10) Pub. No.: US 2023/0185980 A1
(43) Pub. Date: Jun. 15, 2023

(54) PHYSICAL MODEL GENERATION APPARATUS, CONTROL METHOD, AND NON-TRANSITORY COMPUTER-READABLE STORAGE MEDIUM

(71) Applicant: NEC Corporation, Minato-ku, Tokyo (JP)

(72) Inventors: Taniya SINGH, Tokyo (JP); Masafumi Watanabe, Tokyo (JP)

(73) Assignee: NEC Corporation, Minato-ku, Tokyo (JP)

(21) Appl. No.: 17/924,726

(22) PCT Filed: May 19, 2020
(86) PCT No.: PCT/JP2020/019784

§ 371 Date: Nov. 11, 2022

(51) Int. Cl. G06F 30/13; G06F 30/18

(52) U.S. Cl. CPC G06F 30/13; G06F 30/18

(57) ABSTRACT

A physical model generation apparatus (2) acquires design information of a target control system, and generate plant architecture information from the design information. The plant architecture information describes physical components and connections therebetween included in the target control system.

The physical model generation apparatus (2) generates component state information that describes possible states for each physical component described in the plant architecture information. The physical model generation apparatus (2) acquires general behavior information that describes general behavior for each types of physical components. The physical model generation apparatus (2) generates physical model of the target control system based on the plant architecture information, the component state information, and the general behavior information.

### TECHNICAL FIELD

The present disclosure generally relates to a security risk assessment of a control system, in particular, relates to a physical model which is necessary to conduct the security risk assessment.

### BACKGROUND ART

Security risk assessment of a control system requires a physical model of the control system to be constructed. The control system consists of physical components which include one or more sensors, actuators, controllers, and other pieces of equipment. Various simulations are run on this physical model to assess the potential attack paths in the control system.

Patent Literature 1 discloses a method of constructing digital controllers/device drivers automatically from Finite State Machine (FSM) models.

The method includes building a specification of the task to be performed. The invention disclosed by Patent Literature 1 uses description of a physical machine and a library of models as input to build the specification.

### CITATION LIST

### Patent Literature

PTL1: U.S. Pat. No. 5,831,853A

### SUMMARY OF INVENTION

### Technical Problem

It is extremely time consuming for an engineer to construct a physical model manually by understanding a design information, e.g. P&ID (Piping Instrumentation Diagram), of a control system even if it consists of a small number of physical components. Patent literature 1 does not disclose a technique to facilitate the construction of the physical model.

An objective of the present disclosure is to provide a technique for facilitating the construction of the physical model of the control system.

### Solution to Problem

The present disclosure provides a physical model generation apparatus comprising at least one processor and a memory storing instructions. The at least one processor is configured to execute the instructions to: acquire design information of a target control system; generate plant architecture information from the design information, the plant architecture information describing physical components and connections therebetween included in the target control system; generate component state information that describes possible states for each physical component described in the plant architecture information; acquire general behavior information that describes general behavior for each types of physical components; and generate physical model of the target control system based on the plant architecture information, the component state information, and the general behavior information.

The present disclosure provides a control method performed by a computer. The control method comprises: acquiring design information of a target control system; generating plant architecture information from the design information, the plant architecture information describing physical components and connections therebetween included in the target control system; generating component state information that describes possible states for each physical component described in the plant architecture information; acquiring general behavior information that describes general behavior for each types of physical components; and generating physical model of the target control system based on the plant architecture information, the component state information, and the general behavior information.

The present disclosure provides a non-transitory computer-readable storage medium storing a program that causes a computer to perform each step of the above-mentioned control method.

### Advantageous Effects of Invention

According to the present disclosure, it is possible to provide a technique for facilitating the construction of the physical model of the control system.

### BRIEF DESCRIPTION OF DRAWINGS

FIG. 1 is a block diagram illustrating a functional configuration of a physical model generation apparatus 2 of the first example embodiment.

FIG. 2 is a block diagram illustrating an example of the hardware configuration of a computer realizing the physical model generation apparatus.

FIG. 3 is a flowchart illustrating a flow of processes performed by the physical model generation apparatus of the 1st example embodiment.

FIG. 4 illustrates a P&ID of an example of the target control system.

FIG. 5A illustrates an example of the design information that describes the P&ID of the target control system shown in FIG. 4 in an XML format.

FIG. 5B illustrates an example of the design information that describes the P&ID of the target control system shown in FIG. 4 in an XML format.

FIG. 5C illustrates an example of the design information that describes the P&ID of the target control system shown in FIG. 4 in an XML format.

FIG. 5D illustrates an example of the design information that describes the P&ID of the target control system shown in FIG. 4 in an XML format.

FIG. 5E illustrates an example of the design information that describes the P&ID of the target control system shown in FIG. 4 in an XML format.

FIG. 6 is a flowchart illustrating a flow of processes performed by the plant architecture generation unit 3.

FIG. 7 illustrates XPaths to the first target element and the second target element in the example case.

FIG. 8 illustrates the COMPONENT_LIST created in the example case.

FIG. 9 illustrates the CONNECTION_LIST created in the example case.

FIG. 10 illustrates the SORTING_LIST created is the example case.

FIG. 11 illustrates the CONNECTION_LIST after the said replacement.

FIG. 12 shows the plant architecture information generated by the plant architecture generation unit.

FIG. 13 illustrates the P&ID of a pipe segment.

FIG. 14 illustrates the CONNECTION_LIST before replacement of tuples.

FIG. 15 illustrates the SORTING_LIST before sorting.

FIG. 16 illustrates the CONNECTION_LIST after the replacement.

FIG. 17 illustrates an example of the type state information.

FIG. 18 illustrates an example of the controller program.

FIG. 19 illustrates an example of the I/O setting information.

FIG. 20 illustrates an example of the component state information created by the state extraction unit.

FIG. 21A illustrates an example of the general behavior information.

FIG. 21B illustrates an example of the general behavior information.

FIG. 21C illustrates an example of the general behavior information.

FIG. 22 illustrates the keywords table.

FIG. 23 is a flowchart illustrating a flow of processes performed by the behavior aggregation unit.

FIG. 24 illustrates the ON-states and the OFF-states.

FIG. 25A illustrates the physical model generated in the example case.

FIG. 25B illustrates the physical model generated in the example case.

FIG. 25C illustrates the physical model generated in the example case.

FIG. 25D illustrates the physical model generated in the example case.

FIG. 26 illustrates a functional configuration of the physical model generation apparatus of the 2nd example embodiment.

FIG. 27 is a flowchart illustrating the processes performed by the physical model generation apparatus of the 2nd example embodiment.

FIG. 28 is a flowchart illustrating an example working of the step S405 in detail.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary.

### First Example Embodiment

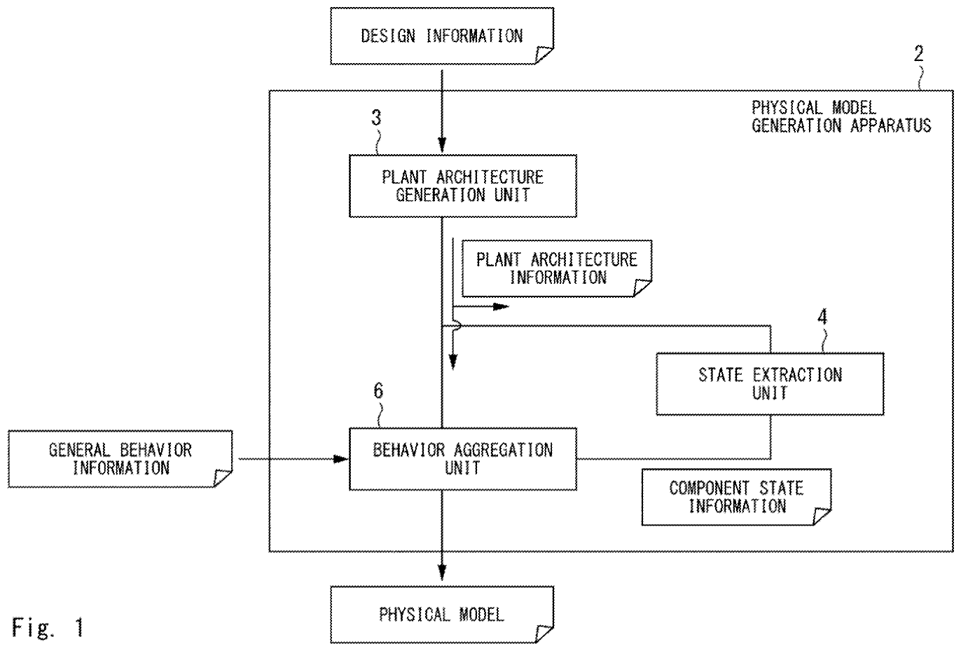

FIG. 1 is a block diagram illustrating a functional configuration of a physical model generation apparatus 2 of the 1st example embodiment. The physical model generation apparatus 2 acquires design information of a control system to be constructed (hereinafter, target control system), and generates a physical model of the target control system based on the acquired design information. To achieve this goal, the physical model generation apparatus 2 includes the plant architecture generation unit 3, the state extraction unit 4, and the behavior aggregation unit 6.

The plant architecture generation unit 3 acquires the design information, and generate plant architecture information. The design information describes physical components included in the target control system, and connections among the physical components. The physical components may include one or more sensors, actuators, controllers, and other pieces of equipment. The sensors may include a water level indicator, a flow indicator, a speed indicator, a manometer, a thermometer, and so on. The actuators include, for example, a motor valve, a pump, a heater, and so on. The controller includes, for example, the Programmable Logic Controller (PLC) and the Distributed Control System (DCS) which monitors and controls the physical components in the target control system. The equipment includes a tank, a piping segment, a heat exchanger, and so on.

The design information may be an XML document that shows a P&ID of the target control system. However, the format of the design information is not limited to XML. In addition, a concrete way of describing the design of the control system is not limited to use P&ID.

The plant architecture information generated by the plant architecture generation unit 3 is a comprehensive description of the physical components and their connections in the target control system. Specifically, the plant architecture information contains component items. The component item is a description of a corresponding physical component included in the target control system. For example, the component item may contain the identifier, name, type, and a list of connection items. The component item may further contain the position and size of the corresponding physical component. Each of the connection items may contain the port, connected component name, and direction for a connection.

The state extraction unit 4 acquires the plant architecture information and generates component state information. The component state information describes possible states for each component shown in the plant architecture information.

The behavior aggregation unit 6 acquires the plant architecture information, the component state information, and general behavior information; and generates the physical model of the target control system. The general behavior information describes the general behavior for each types of physical components.

### Example of Advantageous Effect

According to the physical model generation apparatus 2 of the 1st example embodiment, the physical model of the target control system is generated from the design information of the target control system. Thus, a user can obtain the physical model of the target control system more easily than the case where the user has to manually generate the physical model of the target control system by understanding the design information by herself.

Hereinafter, the detail of the physical model generation apparatus 2 of the 1st example embodiment will be described.

### Example of Hardware Configuration

The physical model generation apparatus 2 may be realized by one or more computers. Each of the one or more computers may be a special-purpose computer manufactured for implementing the physical model generation apparatus 2, or may be a general-purpose computer like a personal computer (PC), a server machine, or a mobile device.

The physical model generation apparatus 2 may be realized by installing an application in the computer. The application is implemented with a program that causes the computer to function as the physical model generation apparatus 2. In other words, the program is an implementation of the functional units of the physical model generation apparatus 2.

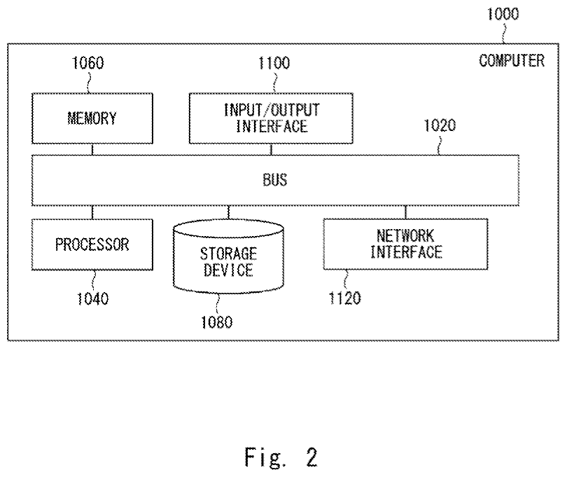

FIG. 2 is a block diagram illustrating an example of the hardware configuration of a computer 1000 realizing the physical model generation apparatus 2. In FIG. 2, the computer 1000 includes a bus 1020, a processor 1040, a memory 1060, a storage device 1080, an input/output (I/O) interface 1100, and a network interface 1120.

The bus 1020 is a data transmission channel in order for the processor 1040, the memory 1060, the storage device 1080, and the I/O interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The I/O interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the physical model generation apparatus 2. In addition, the storage device 1080 may store the design information and the general behavior information. However, the physical model generation apparatus 2 may obtain one or more of these pieces of information from one or more storage devices that are installed outside the computer 1000.

The hardware configuration of the computer 1000 is not limited to the configuration shown in FIG. 2. For example, as mentioned-above, the physical model generation apparatus 2 may be realized by plural computers. In this case, those computers may be connected with each other through the network.

### Flow of Process

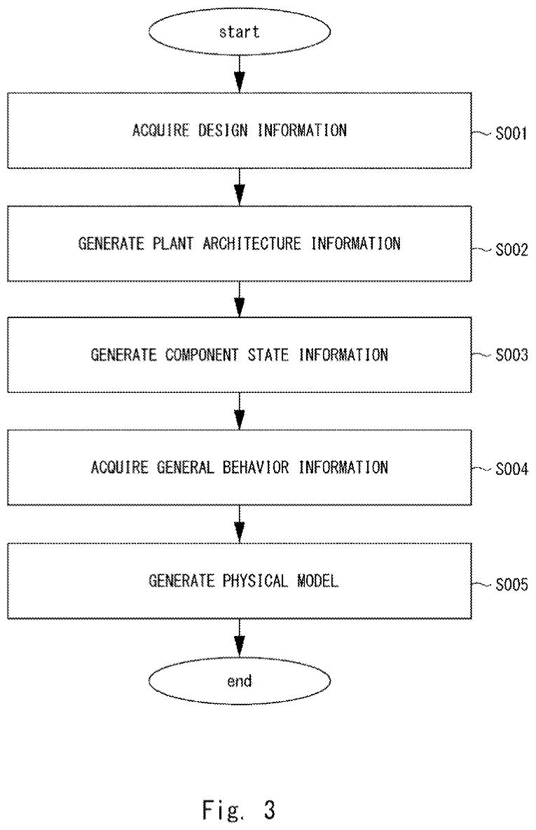

FIG. 3 is a flowchart illustrating a flow of processes performed by the physical model generation apparatus 2 of the 1st example embodiment. The plant architecture generation unit 3 acquires the design information (S001). The plant architecture generation unit 3 generates the plant architecture information based on the design information (S002). The state extraction unit 4 generates the component state information based on the plant architecture information (S003). The behavior aggregation unit 6 acquires general behavior information (S004). The behavior aggregation unit 6 generates the physical model based on the plant architecture information, the component state information, and the general behavior information (S005).

### Example of Design Information

As described above, the design information describes physical components included in the target control system, and connections among the physical components. Hereinafter, as an example case, the design information that represents a P&ID of the target control system in an XML format will be described.

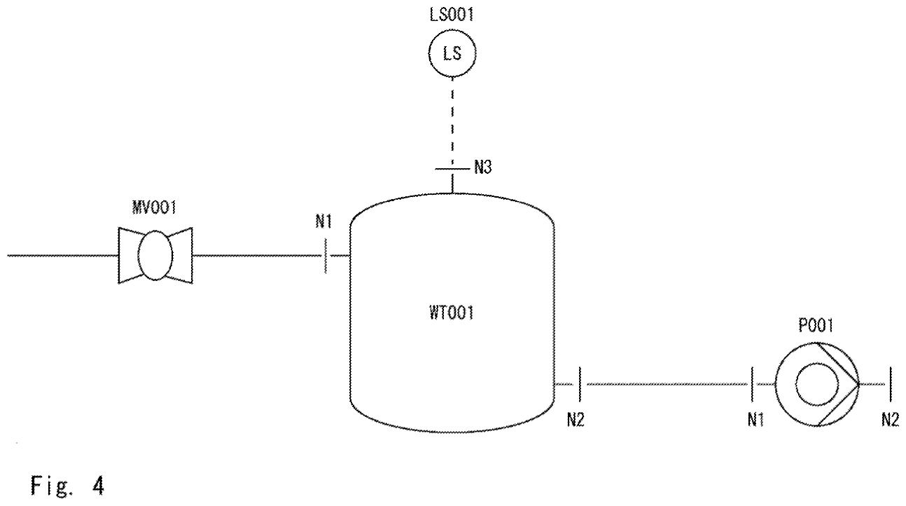

FIG. 4 illustrates a P&ID of an example of the target control system. This target control system includes a motor valve MV001, a level sensor LS001, a pump P001 with two nozzles, and a water tank WT001 with three nozzles.

The water inlet pipe is attached to the WT001 and the MV001 is installed at the middle of it. While the MV001 is open, water is injected into the WT001 through the water inlet pipe and the nozzle N1. The water outlet pipe is laid between the WT001 and the P001. While the P001 is running, the water is drained from the WT001 through the nozzle N2 and the water outlet pipe. The LS001 is installed at the WT001. The LS001 detects the water level in the WT001 through nozzle N3. The signal line is laid between the LS001 and the WT001.

The components described in the P&ID may be connected with a controller, such as a PLC. For example, in the example of FIG. 4, three signal lines may be laid between the PLC and the MV001, the PLC and the P001, and the PLC and the LS001 (not shown in FIG. 4). The PLC sends electrical signal through the said signal line to open or close the MV001, to run or stop the P001 and to receive the water level in the WT001 from the LS001 respectively. The PLC controls the MV001 and the P001 according to the water level in the WT001. The conditions and procedures to control them are defined as a program written in ST.

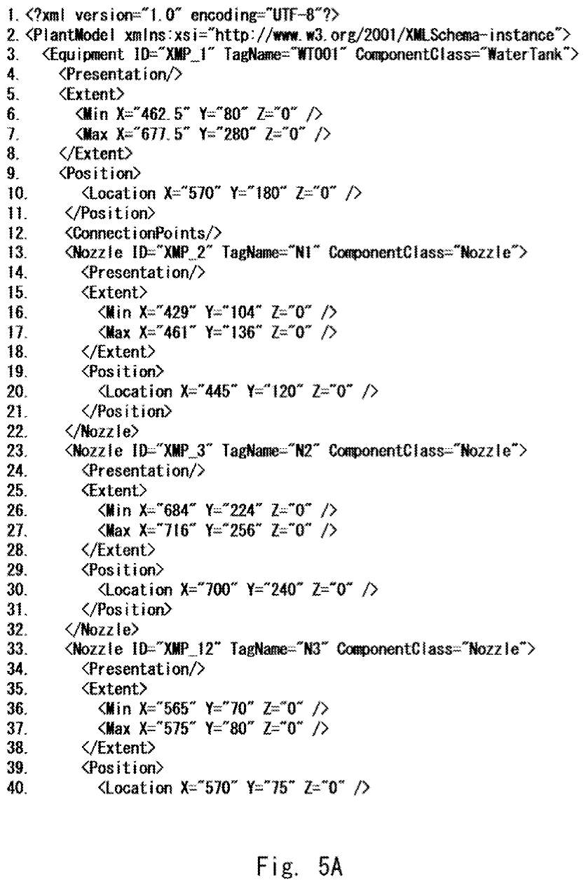

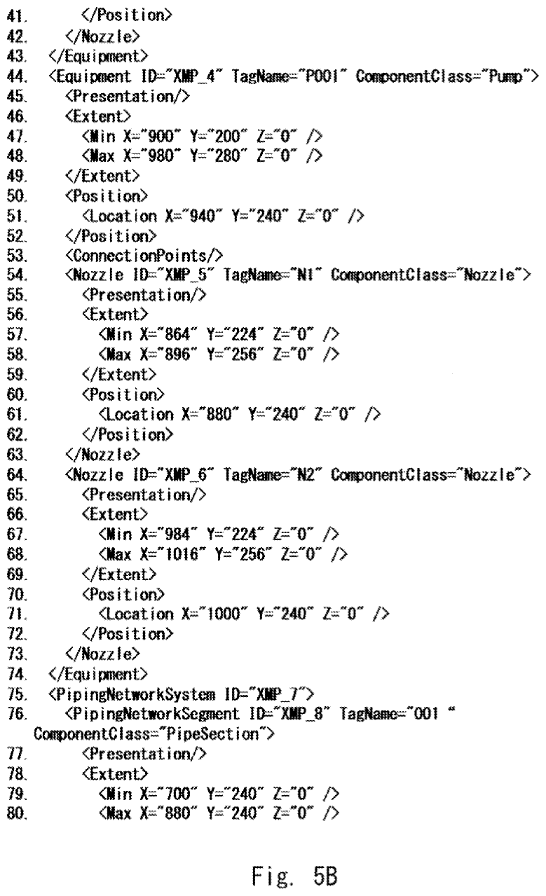

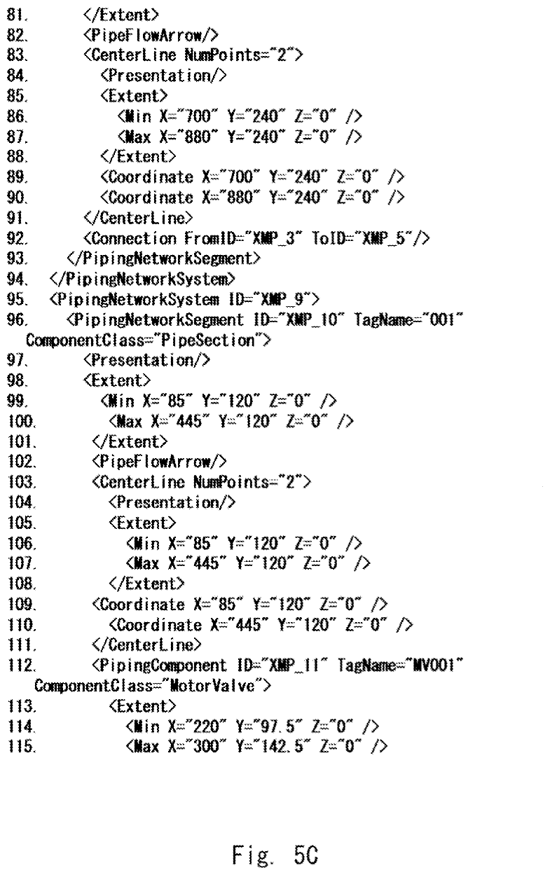

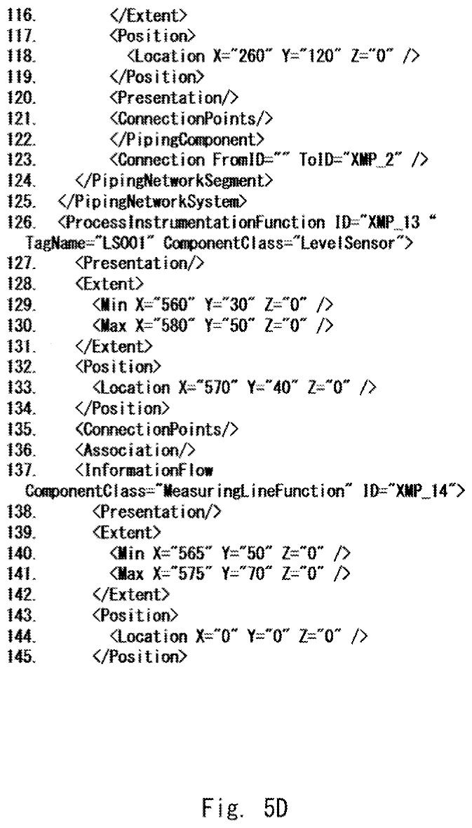

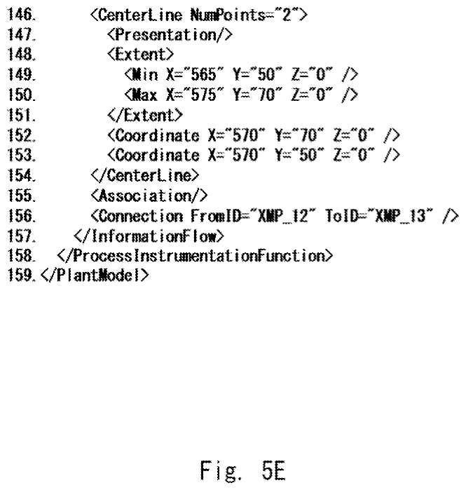

FIGS. 5 illustrate an example of the design information that describes the P&ID of the target control system shown in FIG. 4 in an XML format. In this example, the design information conforms to a specific XML schema definition which is called Proteus XML (formerly called XMpLant.)

The WT001 and the P001 are described by Equipment XML elements. Nozzles equipped to them are described by Nozzle XML elements as children of the said Equipment XML elements. The water inlet pipe and the water outlet pipe are described by PipingNetworkSegment XML elements. The MV001 attached to the water inlet pipe is described by a PipingComponent XML element as a child of the said PipingNetworkSegment XML element. The LS001 is described by a ProcesslnstrumentationFunction XML element. The signal line laid between the WT001 and LS001 is described by an InformationFlow XML element as a child of the said ProcesslnstrumentationFunction XML element.

### Acquisition of Design Information: S001

The plant architecture generation unit 3 acquires the design information (S001). There may be a variety of ways to acquire the design information. For example, the design information to be acquired by the plant architecture generation unit 3 is stored in advance in a storage device to which the plant architecture generation unit 3 has access. In this case, the plant architecture generation unit 3 read the design information out of the storage device. In another example, the plant architecture generation unit 3 may receive the design information sent from arbitrary device. In another example, the design information is manually input to the physical model generation apparatus 2 by a user, and the plant architecture generation unit 3 acquires the design information input by the user.

### Generation of Plant Architecture Information: S002

The plant architecture generation unit 3 generates the plant architecture information based on the design information (S002). The following is an example way of generating the plant architecture information from the design information that describes a P&ID of the target control system in an XML format shown in FIG. 5.

Firstly, the plant architecture generation unit 3 searches for the first target XML elements in the design information. The first target XML element and its descendants contain information of a physical component. The plant architecture generation unit 3 keeps XPaths which specify the location paths to the first target XML elements in a memory, and uses these XPaths in the said search.

From each of the first target XML elements found in the said search, the plant architecture generation unit 3 extracts the ID attribute value, the TagName attribute value, and the ComponentClass attribute value for the identifier, the name, and the type of the physical component respectively. For each of the first target XML elements, the plant architecture generation unit 3 creates a tuple which contains the said identifier, name, and type.

If the first target XML element corresponding to physical component C1 is a descendant of another first target XML element corresponding to physical component C0, then the identifier of the physical component C0 is added to the said tuple for the physical component C1 as parent.

In addition, the plant architecture generation unit 3 may extract a coordinate (position) from the first target XML element and its descendants for the position of the physical component. The plant architecture generation unit 3 may extract coordinates from the first target XML element and its descendants, and calculate width and height for the size of the physical component. The position and the size are added to the said tuple.

The plant architecture generation unit 3 keeps a list called COMPONENT_LIST in a memory, and adds the said tuple to the COMPONENT_LIST.

Secondly, the plant architecture generation unit 3 searches for the second target XML elements in the design information. The second target XML element and its descendants contain a connection item that represents a connection between two physical components. The plant architecture generation unit 3 keeps XPaths which specify the location paths to the second target XML elements in a memory, and uses these XPaths in the said search.

From each of the second target XML elements found in the said search, the plant architecture generation unit 3 extracts the ComponentClass attribute value for the type of the connection. The plant architecture generation unit 3 creates a tuple which contains the said type for each of the second target XML element.

The plant architecture generation unit 3 extracts the FromID attribute value for the starting identifier and the ToID attribute value for the ending identifier from the Connection XML element whose parent is the said second target XML element. The starting identifier is an identifier of the physical component from which the connection starts, whereas the ending identifier is an identifier of the physical component to which the connection ends. The plant architecture generation unit 3 adds the said identifiers to the said tuple.

The plant architecture generation unit 3 keeps a list called CONNECTION_LIST in a memory, and adds the said tuple to the CONNECTION_LIST.

In case that any physical component is attached to the middle of the said connection, the plant architecture generation unit 3 may search for first target XML elements in the descendants of the said second target XML element. From each of the first target XML element found in the said search, the plant architecture generation unit 3 extracts the ID attribute value for the identifier of the physical component attached to the connection. For each of the said first target XML elements, the plant architecture generation unit 3 creates a tuple which contains the said identifier.

In addition, the plant architecture generation unit 3 may extract a coordinate from the said first target XML element and its descendants for the position of the physical component, and add the position to the said tuple.

The plant architecture generation unit 3 keeps a list called SORTING_LIST in a memory for each of the said connection, and adds the said tuple to the SORTING_LIST.

Next, the plant architecture generation unit 3 replaces a tuple in the CONNECTION_LIST with more than one tuple according to the SORTING_LIST as follows.

The plant architecture generation unit 3 creates an empty list called NEW_CONNECTION_LIST in a memory to temporarily store the result of the said replacement. For each of tuples in the CONNECTION_LIST, the plant architecture generation unit 3 identifies the corresponding SORTING_LIST.

If the identified SORTING_LIST has any content, the plant architecture generation unit 3 gets the starting identifier, the ending identifier, and the connection type from the said tuple.

For each of tuples in the identified SORTING_LIST, the plant architecture generation unit 3 gets the identifier from the said tuple for the middle identifier; creates a tuple which contains the said starting identifier, the middle identifier as the ending identifier for this tuple, and the connection type; adds the created tuple to the NEW_CONNECTION_LIST; and set the starting identifier as the middle identifier.

After parsing the all tuples in the SORTING_LIST, the plant architecture generation unit 3 compares the said starting identifier and the said ending identifier. If they are different, the plant architecture generation unit 3 creates a tuple which contains the said starting identifier, the ending identifier, and the said connection type; and adds the created tuple to the NEW_CONNECTION_LIST.

If the identified SORTING_LIST has no content, the plant architecture generation unit 3 creates a copy of the said tuple in the CONNECTION_LIST; and adds the created tuple to the NEW_CONNECTION_LIST.

After parsing the all tuples in the CONNECTION_LIST, the plant architecture generation unit 3 clears the CONNECTION_LIST, and moves all the tuples in the NEW_CONNECTION_LIST to the CONNECTION_LIST.

Finally, the plant architecture generation unit 3 composes the plant architecture by using information in the said COMPONENT_LIST and CONNECTION_LIST as follows.

The plant architecture generation unit 3 searches, in the COMPONENT_LIST, for the component tuples which do not include a parent; then gets the identifier, name, and type from each of the component tuples found in the said search. If the position and the size are contained in the said component tuple, the plant architecture generation unit 3 may get the said position and size from the said component tuple. For each of the said component tuples, the plant architecture generation unit 3 creates a new component item which contains the said identifier, name, and type. The plant architecture generation unit 3 creates an empty list of connection items, and adds to the said component item. The plant architecture generation unit 3 may add the said position and size to the said component item.

For each of the connection tuples in the CONNECTION_LIST; the plant architecture generation unit 3 set the port and direction, which are temporary variables allocated in a memory, as “OUT” and “flow-out” respectively; calls the connection composing process; set the port and direction as “IN” and “flow-in” respectively; and calls the connection composing process.

The connection composing process is explained here in detail. The plant architecture generation unit 3 searches in the COMPONENT_LIST for a component tuple whose identifier is equal to the starting identifier in the said connection tuple. If the said component tuple has a parent, the plant architecture generation unit 3 set the said port as the name in the said component tuple; and searches in the COMPONENT_LIST for another component tuple whose identifier is equal to the said parent. The plant architecture generation unit 3 set the subject component identifier, which is a temporary variable allocated in a memory, as the identifier in the component tuple found in the last search.

The plant architecture generation unit 3 searches in the COMPONENT_LIST for a component tuple whose identifier is equal to the ending identifier in the said connection tuple. If the said component tuple has a parent, the plant architecture generation unit 3 searches in the COMPONENT_LIST for another component tuple whose identifier is equal to the said parent. The plant architecture generation unit 3 set the connected component name, which is a temporary variable allocated in a memory, as the name in the said component tuple found in the last search.

The plant architecture generation unit 3 creates a connection item which contains the said port, connected component name, and direction. The plant architecture generation unit 3 searches in the plant architecture information for a component item whose identifier is equal to the said subject component identifier, and adds the said connection item to the list of connection items in the component item found in the said search.

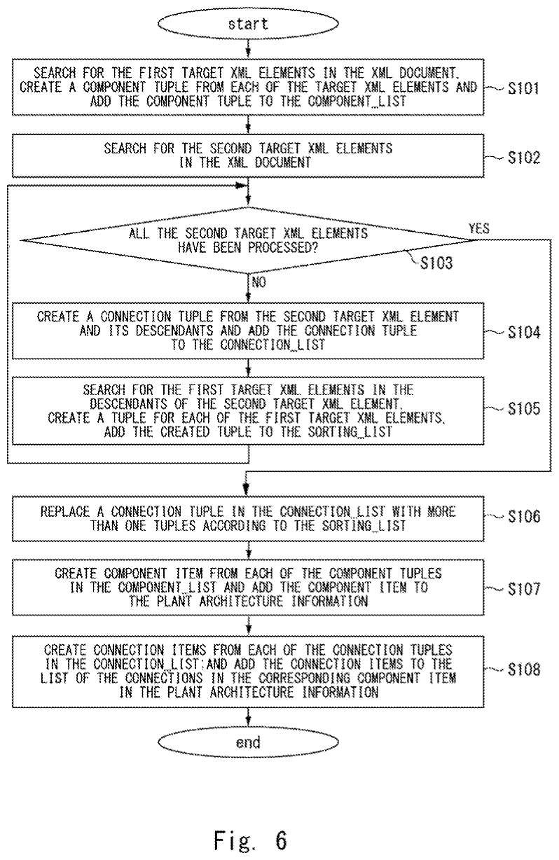

FIG. 6 is a flowchart illustrating a flow of processes performed by the plant architecture generation unit 3. The plant architecture generation unit 3 searches for the first target XML elements in the design information; creates a component tuple from each of the said first target XML elements; and adds the said component tuples to a component list (S101). The plant architecture generation unit 3 searches for the second target XML elements in the design information (S102). The plant architecture generation unit 3 checks if all the second target XML elements have been processed or not (S103). If all the second target XML elements have been processed, the step S106 is executed. If not, the step S104 is executed.

The plant architecture generation unit 3 creates a connection tuple from the said second target XML element and its descendants; and adds the said connection tuple to a CONNECTION_LIST (S104). The plant architecture generation unit 3 searches for the first target XML elements in the descendants of the said second target XML element; creates a tuple for each of the first target XML elements; adds the created tuple to the SORTING_LIST (S105). Then, the step S103 is executed again.

The plant architecture generation unit 3 replaces a connection tuple in the CONNECTION_LIST with more than one tuple according to the SORTING_LIST (S106). The plant architecture generation unit 3 creates a component item from each of the component tuples in the COMPONENT_LIST; and adds the said component item to the plant architecture information (S107).

The plant architecture generation unit 3 creates connection items from each of the said connection tuples in the CONNECTION_LIST; and adds the said connection items to the list of connection items in the corresponding component item in the plant architecture information (S108).

### Example Case of Generating Plant architecture

An example case of generating the plant architecture is explained hereinafter by referring figures.

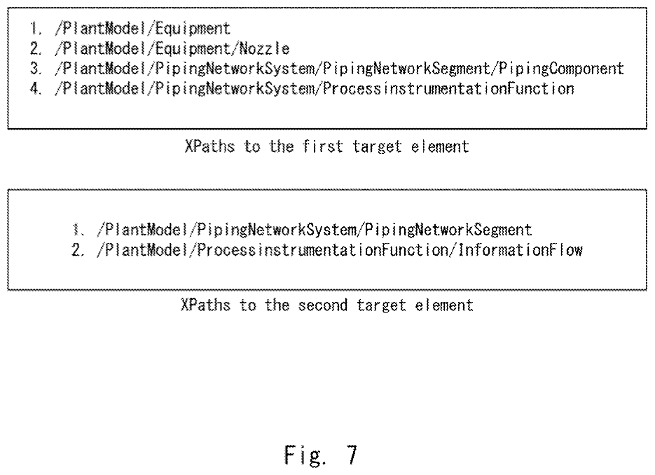

FIG. 7 illustrates XPaths to the first target element and the second target element in the example case. The plant architecture generation unit 3 keeps XPaths shown in the upper box of FIG. 7 to specify location paths to the first target elements. For example, “/PlantModel/Equipment” specifies an Equipment XML element which is a child of the PlantModel XML element, and the said PlantModel XML element is the root node of the design information.

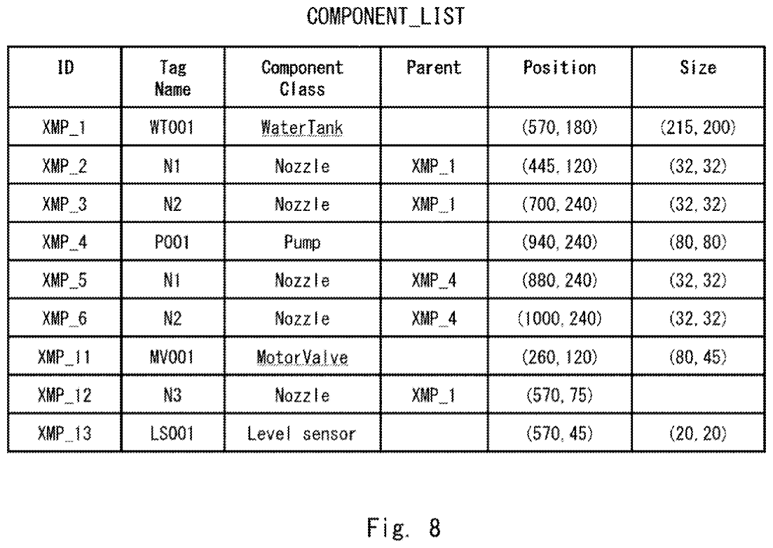

In S101, the plant architecture generation unit 3 finds the following first target XML elements in the design information by using the said XPaths: Equipment XML elements at line 3 and 44; Nozzle XML elements at line 13, 23, 33, 54, and 64; PipingComponent XML element at line 112; and ProcesslnstrumentationFunction XML element at line 126. The plant architecture generation unit 3 creates component tuples from the said first target XML elements and adds them to the COMPONENT_LIST. FIG. 8 illustrates the COMPONENT_LIST created in the example case.

The plant architecture generation unit 3 keeps XPaths shown the lower box of FIG. 7 to specify location paths to the second target elements. For example, “/PlantModel/PipingNetworkSystem/PipingNetworkSegment” specifies a PipingNetworkSegment XML element which is a child of a PipingNetworkSystem XML element, the said PipingNetworkSystem XML element is a child of the PlantModel XML element, and the said PlantModel XML element is the root node of the design information.

In S102, the plant architecture generation unit 3 finds the following second target XML elements in the design information by using the said XPaths: PipingNetworkSegment XML element at line 76 and 96; and InformationFlow XML element at line137.

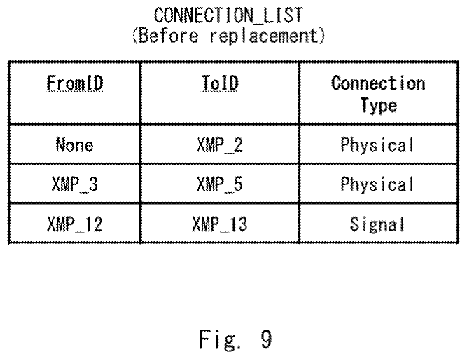

In S104, the plant architecture generation unit 3 creates connection tuples from the said second target XML elements and add them to the CONNECTION_LIST. FIG. 9 illustrates the CONNECTION_LIST created in the example case.

In S105, the plant architecture generation unit 3 finds the following first target XML element by using the said XPaths: PipingComponent XML element at line 112 in the descendants of the PipingNetworkSegment XML element at line 96. The plant architecture generation unit 3 creates a tuple and adds it to the SORTING_LIST.

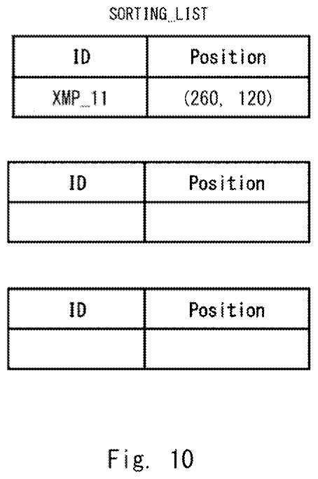

FIG. 10 illustrates the SORTING_LIST created is the example case. There are three SORTING_LIST in FIG. 10. The SORTING_LIST at the top corresponds to the first row of the CONNECTION LIST. The SORTING_LIST in the middle corresponds to the second row of the CONNECTION LIST. The SORTING_LIST at the bottom corresponds to the third row of the CONNECTION LIST.

In S106, the plant architecture generation unit 3 replaces a connection tuple in the CONNECTION_LIST with more than one tuple according to the SORTING_LIST.

For the tuple [“None”, “XMP_2”, “Physical”] in the CONNECTION_LIST; the plant architecture generation unit 3 identifies the SORTING_LIST at the top of FIG. 10 which corresponds to the said tuple; gets the starting identifier “None”, ending identifier “XMP_2”, and the connection type “Physical” from the said tuple.

From the tuple [“XMP_11”, (260, 120)] in the identified SORTING_LIST, the plant architecture generation unit 3 gets the identifier “XMP_11” for the middle identifier; creates a tuple [“None”, “XMP_11”, “Physical”]; adds the created tuple to the NEW_CONNECTION_LIST; and set the starting identifier as “XMP_11”.

The plant architecture generation unit 3 creates a tuple [“XMP_11”, “XMP_2”, “Physical”]; and adds the created tuple to the NEW_CONNECTION_LIST.

For the tuple [“XMP_3”, “XMP_5”, “Physical”] in the CONNECTION_LIST; the plant architecture generation unit 3 identifies the SORTING_LIST in the middle of FIG. 10 which corresponds to the said tuple. Since the said SORTING_LIST has no content, the plant architecture generation unit 3 creates a copy of the said tuple, and adds the created tuple to the NEW_CONNECTION_LIST.

For the tuple [“XMP_12”, “XMP_13”, “Signal”] in the CONNECTION_LIST; the plant architecture generation unit 3 identifies the SORTING_LIST at the bottom of FIG. 10 which corresponds to the said tuple. Since the said SORTING_LIST has no content, the plant architecture generation unit 3 creates a copy of the said tuple, and adds the created tuple to the NEW_CONNECTION_LIST.

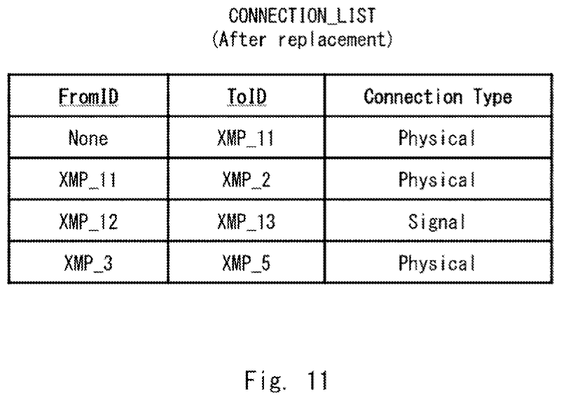

FIG. 11 illustrates the CONNECTION_LIST after the said replacement.

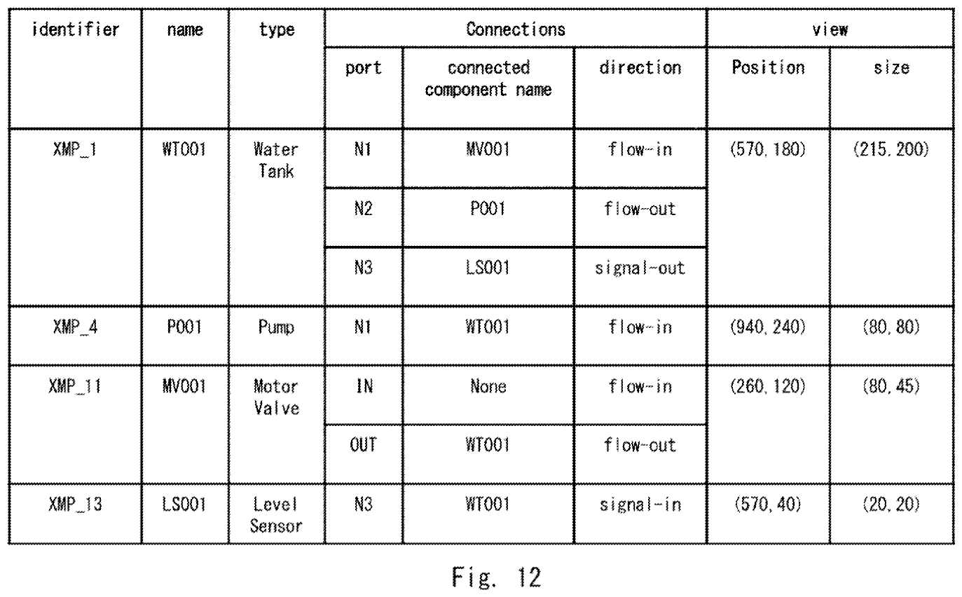

In S107 and S108, the plant architecture generation unit 3 generate the plant architecture information from the said COMPONENT_LIST and the said CONNECTION_LIST. FIG. 12 shows the said plant architecture information generated by the plant architecture generation unit 3. The plant architecture information has four component items. The first component item contains “XMP_1” for identifier, “WT001” for name, and “WaterTank” for type. The said component item contains three connection items for connections. The first connection item contains “N1” for the port, “MV001” for the connected component name, and “flow-in” for the direction. The second connection item contains “N2” for the port, “P001” for the connected component name, and “flow-out” for the direction. The third connection item contains “N3” for the port, “LS001” for the connected component name, and “signal-out” for the direction.

The said component item contains the position (570, 180) and the size (215, 200).

### Another Example Case of Generating Plant architecture Information

If the order of the tuples is not according to the direction of the connection, a SORTING_LIST must be sorted before it is used for replacing the CONNECTION_LIST tuples. Specifically, in such a case, the plant architecture generation unit 3 may identify the direction of the connection by using the position of the physical component which the connection starts from, and the position of the physical component which the connection ends to; and sort the tuples in the SORTING_LIST according to the identified direction.

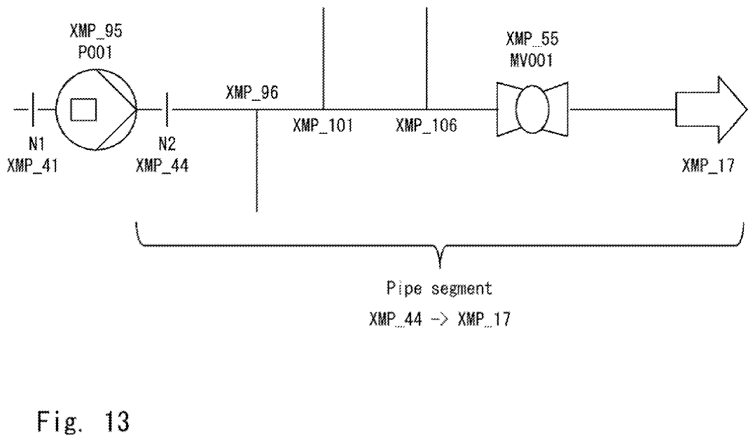

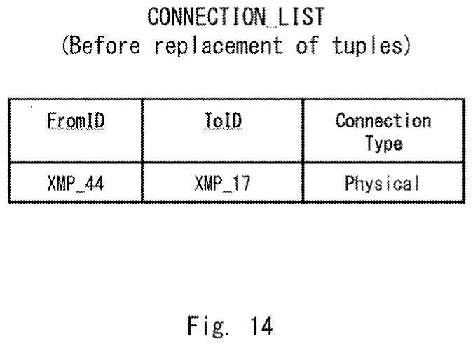

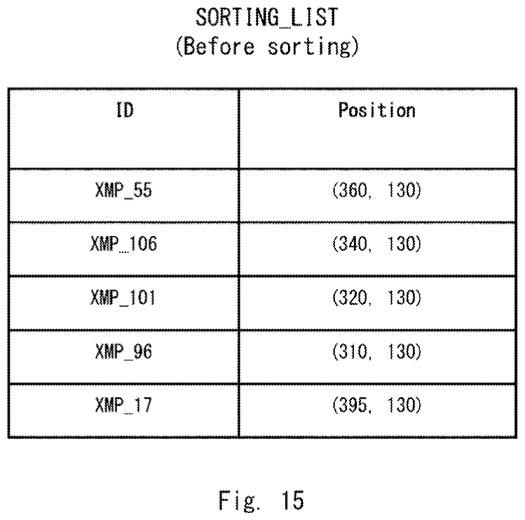

An example of the said sorting is explained hereinafter by referring a figure. FIG. 13 illustrates the P&ID of a pipe segment. FIG. 14 illustrates the CONNECTION_LIST before replacement of tuples. FIG. 15 illustrates the SORTING_LIST before sorting.

From the connection items stored in the CONNECTION_LIST, the plant architecture generation unit 3 gets the starting identifier XMP_44, and the ending identifier XMP_17. The plant architecture generation unit 3 finds the tuple whose identifier is XMP_44 in the COMPONENT_LIST and gets the coordinate (300, 130) from the said tuple; and finds the tuple whose identifier is XMP_17 in the COMPONENT_LIST and gets the coordinate (420, 130) from the said tuple.

The plant architecture generation unit 3 calculates 120 for the remainder in X-axis by subtracting 300 from 420, and zero for the remainder in Y-axis by subtracting 130 from 130; and identifies the direction for each of the axes as follows: (1) the direction is ascending if the said remainder is more than zero, (2) no direction if the remainder equals to zero, and (3) the direction is descending if the remainder is less than zero. In this example, the direction of the connection is ascending in X-axis because the calculated remainder in X-axis is more than zero, and no direction in Y-axis. The plant architecture generation unit 3 sorts the tuples in the SORTING_LIST in ascending order of X-axis.

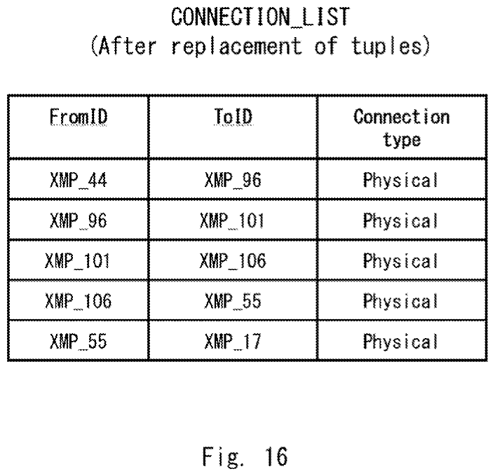

After the sorting of the SORTING_LIST, the plant architecture generation unit 3 perform the replacement on the CONNECTION_LIST. FIG. 16 illustrates the CONNECTION_LIST after the replacement.

### Generation of Component State Information: S003

The state extraction unit 4 generates the component state information based on the plant architecture information generated by the plant architecture generation unit 3 (S003). For example, type state information is used to generate the component state information. The type state information is pre-defined information that describes possible states for each type of components, such as a pump. The said generation of the component state information using the type state information is explained below in detail.

The state extraction unit 4 keeps, in a memory, pre-defined component states for each type of physical component that are described in the type state information. The component sates for a certain type of physical components are pre-defined states which the physical components classified into the said certain type can have.

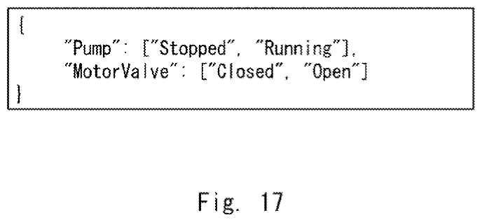

FIG. 17 illustrates an example of the type state information. In this example, the component states [“Stopped”, “Running”] are defined for the type “Pump”, and the component states [“Closed”, “Open”] are defined for the type “MotorValve”.

At the beginning of the extraction, the state extraction unit 4 creates an empty component state information. Then, for each of component items in the plant architecture information, the state extraction unit 4 gets the name and type from the said component item, gets the component states for the said type from the memory (i.e. from the type state information), and adds the said component states with the said name to the said component state information. As a result, the component state information is generated to show possible states for each of the physical components in the target control system.

Note that there may be a variety of ways to acquire the type state information. For example, the type state information to be acquired by the state extraction unit 4 is stored in advance in a storage device to which the state extraction unit 4 has access. In this case, the state extraction unit 4 read the type state information out of the storage device. In another example, the state extraction unit 4 may receive the type state information sent from arbitrary device. In another example, the state extraction unit 4 may obtain the type state information that is manually input by the user of the physical model generation apparatus 2.

Instead of the type state information, the state extraction unit 4 may use a controller program and I/O setting information for generating the component state information. The controller program contains a logic for monitoring and controlling the physical components connected to the controller. For example, the controller program is written in five programming languages namely Instruction List (IL), Structured Text (ST), Ladder Diagram (LD), Function Block Diagram (FBD) and Sequential Function Chart (SFC). An example of the said extraction is explained below.

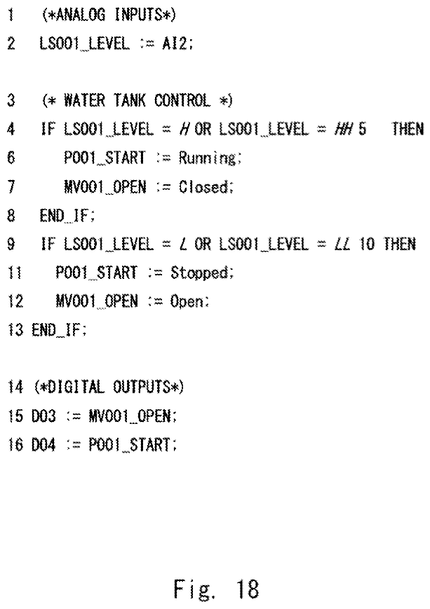

FIG. 18 illustrates an example of the controller program. This controller program is written in ST. A value of the variable AI2 is assigned to the variable LS001_LEVEL at line 2. If the value of the variable LS001_LEVEL is equal to value “H” or “HH” then the value “Running” is assigned to the variable P001_START and the value “Closed” is assigned to the variable MV001_OPEN at the line 4 to 8. If the value of the variable LS001_LEVEL is equal to value “L” or “LL” then the value “Stopped” is assigned to the variable P001_START and the value “Open” is assigned to the variable MV001_OPEN at the line 9 to 13. A value of the variable MV001_OPEN is assigned to the variable DO3 at the line 15. A value of the variable P001_START is assigned to the variable DO4 at the line 16.

The I/O setting information specifies a variable, a tag, or a device which are present in the said controller program; and the corresponding physical component. The physical component may one that is controlled by the corresponding value of the said variable, tag, or device; or that sends values to be assigned to the said variable, tag, or device.

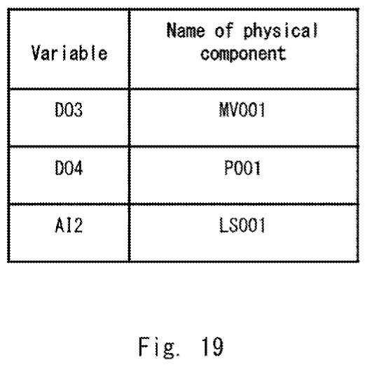

FIG. 19 illustrates an example of the said I/O setting information. The first item contains MV001 for a physical component and DO3 for a variable. The second item contains P001 for a physical component and DO4 as a variable. The third item contains LS001 for physical component and AI2 for variable.

When the state extraction unit 4 gets the name “P001” and the type “Pump” from the second component item in the said plant architecture information; the state extraction unit 4 identifies the DO4 in the second item of I/O setting information as the variable used to control the P001; identifies the variable P001_START at the line 16 of the said controller program as the variable which contains a value to be assigned to the DO4; identifies the value “Running” at the line 6, and the value “Stopped” at the line 11 of the said controller program, as the values to be assigned to the P001_START; and adds the identified values [“Running”, “Stopped”] with the said name “P001” to the component state information. Similarly, the state extraction unit 4 identifies values used to control the MV001.

Based on the controller program and the I/O setting information, the state extraction unit 4 can generate a physical model for the physical components with the same type but the states which are actually used for control is different each other.

Note that the controller program and I/O setting information may be acquired by a similar way of acquiring the type state information.

### Example Case of Generating Component State Information

An example case of generating the component state information is explained hereinafter by referring figures. In this example, it is assumed that the design information shows in FIG. 5 and the type state information shown in FIG. 17 are acquired by the physical model generation apparatus 2. Thus, the plant architecture information is supposed to be one shown in FIG. 12.

At the beginning of the extraction, the state extraction unit 4 creates an empty component state information. Then the state extraction unit 4 gets the name “WT001” and the type “WaterTank” from the first component item in the said plant architecture information. However, since component states for the type “WaterTank” are not defined in the state definition information, the state extraction unit 4 does not update the component state information.

The state extraction unit 4 gets the name “P001” and the type “Pump” from the second component item in the said plant architecture information; gets the component states [“Stopped”, “Running”] for the said type from the memory; and adds the said component states with the said name to the component state information.

Similarly, the component state extractor unit 4 updates the component state information for each of the remaining component items in the said plant architecture information.

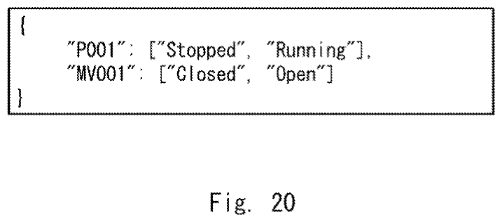

FIG. 20 illustrates an example of the component state information created by the state extraction unit 4. The said component state information contains the states [“Stopped”, “Running”] for the physical component “P001”, and the states [“Closed”, “Open”] for the physical component “MV001”.

### Acquisition of General Behavior Information: S004

The behavior aggregation unit 6 acquires the general behavior information (S004). The general behavior information describes the general behavior for each types of physical components. For example, the said general behavior may be a code snippet in a formal specification language describing the common behavior of the said type of the physical component. The said general behavior can contain keywords to be replaced with concrete values.

The general behavior information may be composed as a table having two columns: the types of the physical components are stored in the first column; and the corresponding general behaviors are stored in the second column.

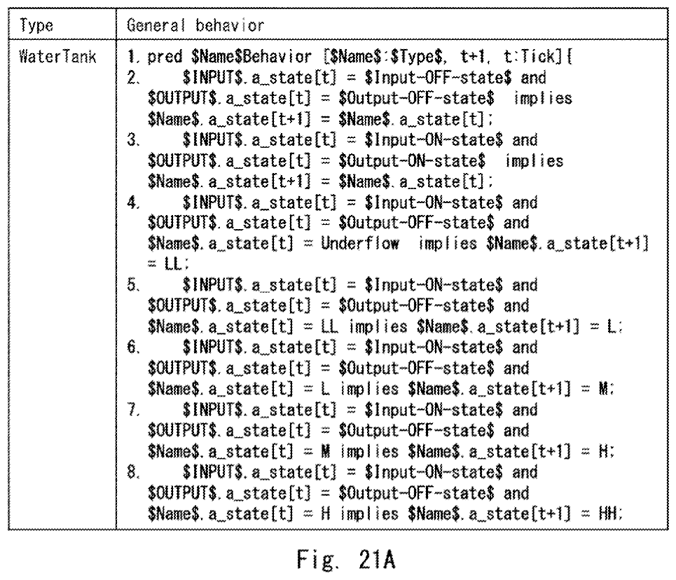

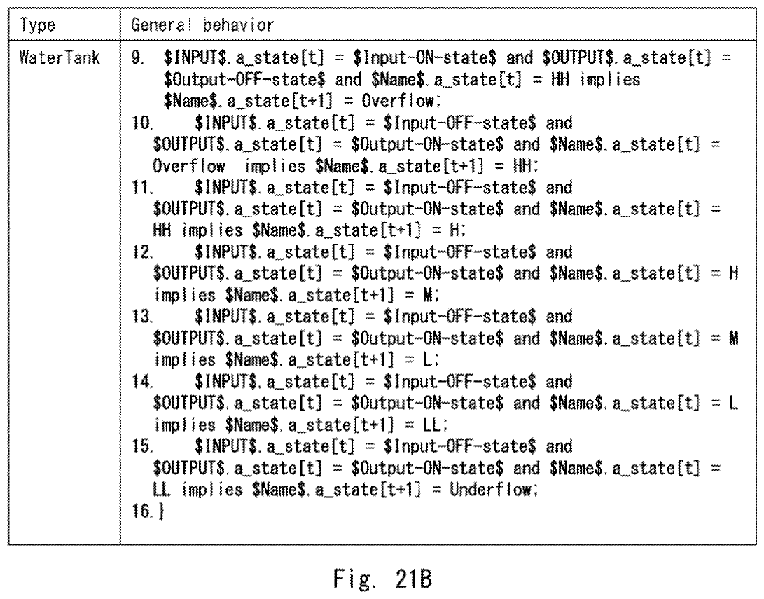

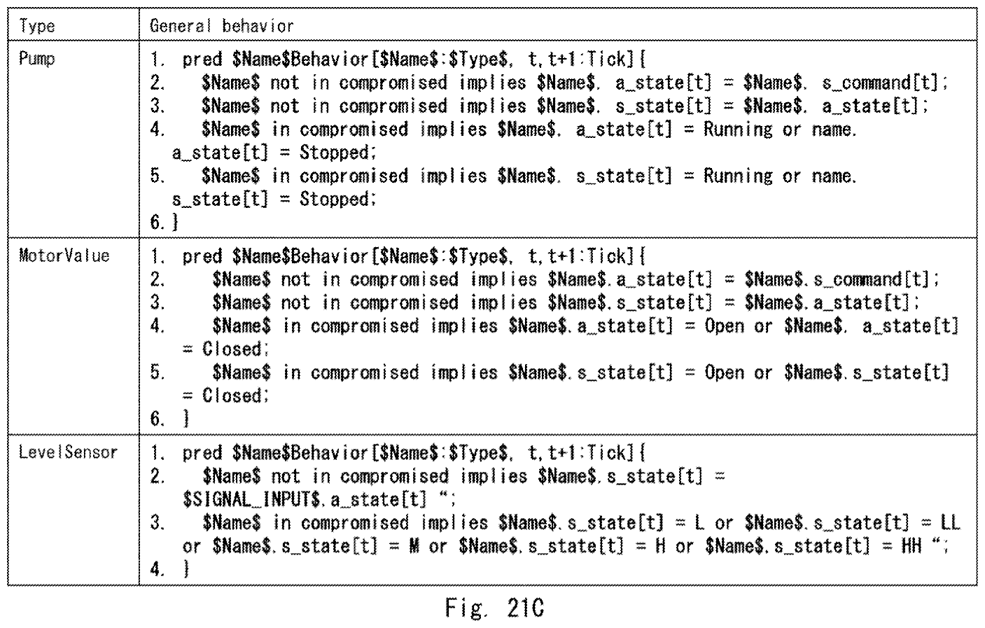

FIGS. 21 illustrate an example of the general behavior information. FIGS. 21A and B describes a behavior which is common in water tanks, and is stored with the type “WaterTank”. The general behavior in the 1st row of FIG. 21C describes a behavior which is common in motor valves, and is stored with the type “MotorValve”. The general behavior in the 2nd row of FIG. 21C describes a behavior which is common in pumps, and is stored with the type “Pump”. The general behavior in the 3rd row of FIG. 21C describes a behavior which is common in level sensors, and is stored with the type “LevelSensor”.

Note that there may be a variety of ways to acquire the general behavior information. For example, the general behavior information to be acquired by the behavior aggregation unit 6 is stored in advance in a storage device to which the behavior aggregation unit 6 has access. In this case, the behavior aggregation unit 6 read the general behavior information out of the storage device. In another example, the behavior aggregation unit 6 may receive the general behavior information sent from arbitrary device. In another example, the behavior aggregation unit 6 may receive a user input that describes the general behavior information.

### Generation of Physical Model: S005

The behavior aggregation unit 6 further acquires the plant architecture information generated by the plant architecture generation unit 3 and the component state information generated by the state extraction unit 4. Then, the behavior aggregation unit 6 generates the physical model based on the acquired pieces of information (S005). The said generation of the physical model is explained below in detail.

Firstly, the behavior aggregation unit 6 collects the concrete values for each of the component items in the plant architecture information as follows.

The behavior aggregation unit 6 gets the name, the type, and the list of connection items from the said component item; stores the said name in a memory for a concrete value called Comp_Name; and stores the said type in a memory for a concrete value called Comp_Type.

The behavior aggregation unit 6 searches the list of the connection items for a connection item whose direction is “flow-in.” If such connection item is found, the behavior aggregation unit 6 gets the connected component name from the said connection item, and stores it in a memory for a concrete value called Input_Comp. The behavior aggregation unit 6 searches the said list of the connection items for a connection item whose direction is “flow-out.” If such connection item is found, the behavior aggregation unit 6 gets the connected component name from the said connection item, and stores it in a memory for a concrete value called Output_Comp.

The behavior aggregation unit 6 searches the said list of the connection items for a connection item whose direction is “signal-in.” If such connection item is found, the behavior aggregation unit 6 gets the connected component name from the said connection item, and stores it in a memory for a concrete value called Signal_Input_Comp. The behavior aggregation unit 6 searches the said list of the connection items for a connection item whose direction is “signal-out.” If such connection item is found, the behavior aggregation unit 6 gets the connected component name from the said connection item, and stores in a memory for a concrete value called Signal_Output_Comp.

The behavior aggregation unit 6 keeps pre-defined lists of states which are called ON-states and OFF-states in a memory. Each of states in the ON-states may indicate that the corresponding physical component is active, is having effect on another physical component, or is detecting a state of another physical component. Each of states in the OFF-states may indicate that the corresponding physical component is inactive, is having no effect on the other physical component, or is not detecting the state of the other physical component.

The behavior aggregation unit 6 gets the list of states which is specified by the Input_Comp, from the said component state information. The behavior aggregation unit 6 searches in the said list for the state that matches with a state in the ON-states. If such state is found, the behavior aggregation unit 6 stores the said state in a memory for a concrete value called Input_ON. The behavior aggregation unit 6 searches in the said list for the state that matches with a state in the OFF-states. If such state is found, the behavior aggregation unit 6 stores the said state in a memory for a concrete value called Input_OFF.

Similarly, the behavior aggregation unit 6 gets the list of states which is specified by the Output_Comp, from the said component state information. The behavior aggregation unit 6 searches in the said list for the state that matches with a state in the ON-states. If such state is found, the behavior aggregation unit 6 stores the said state in a memory for a concrete value called Output_ON. The behavior aggregation unit 6 searches in the said list for the state that matches with a state in the OFF-states. If such state is found, the behavior aggregation unit 6 stores the said state in a memory for a concrete value called Output_OFF.

Secondly, the behavior aggregation unit 6 creates the specific behavior for each of the component items in the said plant architecture information as follows.

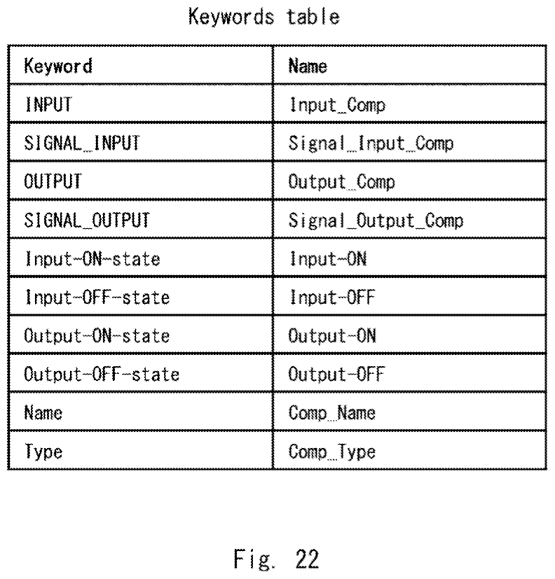

The behavior aggregation unit 6 gets, from the general behavior information, a copy of the general behavior whose corresponding type is equal to the Comp_Type. The behavior aggregation unit 6 keeps, in a memory, a table called keywords table which contains keywords in the “Keyword” column and corresponding names of concrete values in the “Name” column. FIG. 22 illustrates the said keywords table. The behavior aggregation unit 6 searches the copied general behavior for keywords which are defined in the “Keyword” column in the said keywords table. For each of keywords found by the said search, the behavior aggregation unit 6 identifies the name of the concrete value corresponding to the said keyword by looking up the “Keyword” column in the keywords table for the same keyword as the said keyword and then referring the “Name” column for the name of the concrete value; and replaces the said keyword present in the said general behavior with the concrete value specified by the identified name of the concrete value.

Finally, the behavior aggregation unit 6 creates a physical model which includes a list of the said specific behaviors, and outputs the created physical model in arbitrary ways. For example, the behavior aggregation unit 6 may put a plain text file describing the said physical model into a storage device. In another example, the behavior aggregation unit 6 may transfer the said physical model as a plain text or a graphical data to a display device, thereby displaying it on the display device.

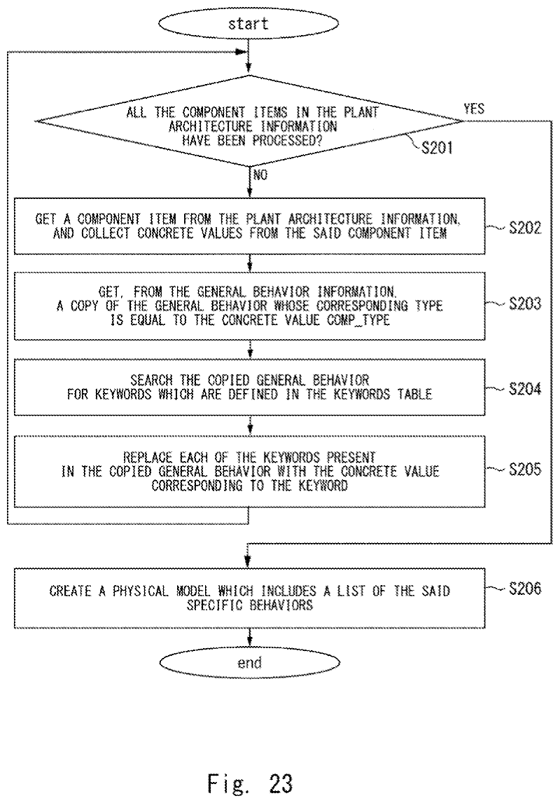

FIG. 23 is a flowchart illustrating a flow of processes performed by the behavior aggregation unit 6. The behavior aggregation unit 6 checks if all the component items in the plant architecture information have been processed or not (S201). If all the component items have been processed, the S206 is executed. If not, the S202 is executed.

The behavior aggregation unit 6 gets a component item from the plant architecture information, and collects concrete values from the said component item, and so on (S202). The behavior aggregation unit 6 gets, from the general behavior information, a copy of the general behavior whose corresponding type is equal to the concrete value Comp_Type (S203).

The behavior aggregation unit 6 searches the copied general behavior for keywords which are defined in the keywords table (S204).

The behavior aggregation unit 6 replaces each of the keywords present in the copied general behavior with the concrete value corresponding to the said keyword (S205), and executes the S201.

The behavior aggregation unit 6 creates a physical model which includes a list of the said specific behaviors, and outputs the said physical model (S206).

### Example Case of Generating Physical Model

An example of the working of the behavior aggregation unit 6 is explained hereinafter by referring figures. In this example, it is assumed that the design information shown in FIG. 5, the type state information shown in FIG. 17, and the general behavior information shown in FIG. 21 are acquired by the physical model generation apparatus 2. Thus, the plant architecture information and the component state information are supposed to be ones shown in FIGS. 12 and 20, respectively.

After the component state information is created, the behavior aggregation unit 6 generates the physical model by referring the said plant architecture information shown in FIG. 12, the said component state information shown in FIG. 20, and the said general behavior information shown in FIG. 21. This step is explained below in detail.

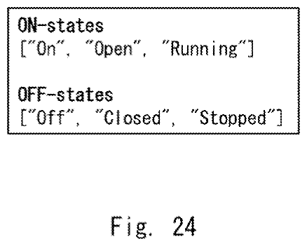

FIG. 24 illustrates the ON-states and the OFF-states which are kept in a memory by the behavior aggregation unit 6 to identify concrete values for the Input_ON, Input_OFF, Output_ON, and Output_OFF. The ON-states contains “On”, “Open”, and “Running”. The OFF-states contains “Off”, “Closed”, and “Stopped”.

In S202, the behavior aggregation unit 6 gets the first component item from the plant architecture information; and collects the following concrete values for the said component item: “WT001” for the Comp_Name, “WaterTank” for the Comp_Type, “MV001” for the Input_Comp, “P001” for the Output_Comp, “LS001” for the Signal_Output_Comp, “Open” for the Input_ON, “Closed” for the Input_OFF, “Running” for the Output_ON, and “Stopped” for the Output_OFF.

In S203, the behavior aggregation unit 6 gets, from the general behavior information, a copy of the said general behavior whose corresponding type is “WaterTank”.

In S204-S205, the behavior aggregation unit 6 creates a specific behavior by finding the keywords in the copied general behavior and replacing the said keywords with the corresponding concrete values as follows: “Name” at lines 1-15 are replaced with “WT001”, “Type” at line 1 is replaced with “WaterTank”, “INPUT” at lines 2-15 are replaced with “MV001”, “OUTPUT” at lines 2-15 are replaced with “P001”, “Input-ON-state” at lines 4-9 are replaced with “Open”, “Input-OFF-state” at lines 10-15 are replaced with “Closed”, “Output-ON-state” at lines 4-9 are replaced with “Running”, and “Output-OFF-state” at lines 10-15 are replaced with “Stopped”.

Similarly, the behavior aggregation unit 6 executes S202-S205 for each of the remaining component items.

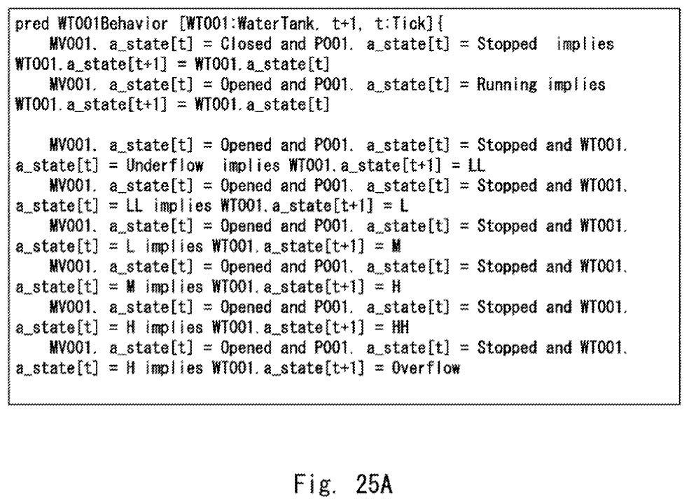

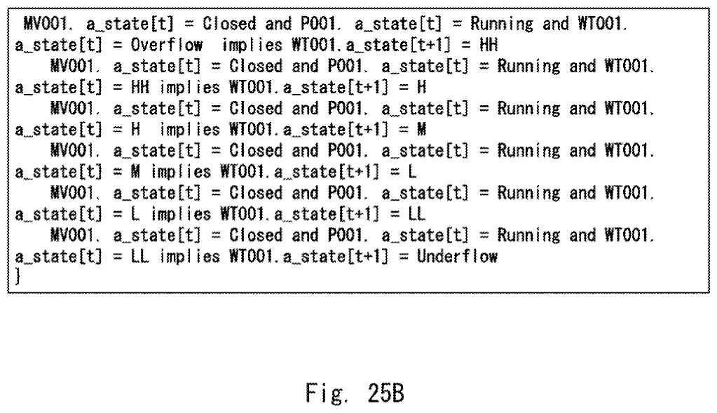

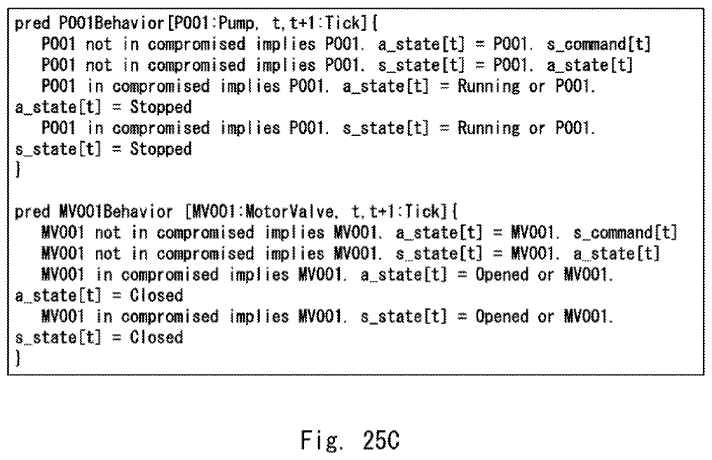

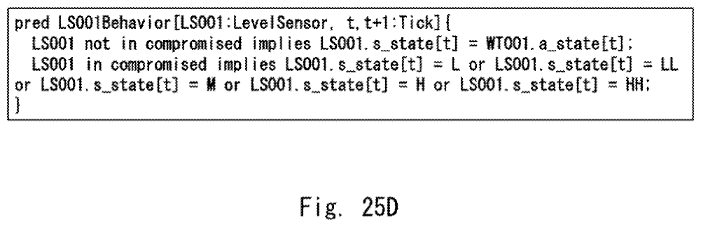

In S206, the behavior aggregation unit 6 creates a physical model which includes a list of the created specific behaviors. FIGS. 25 illustrate the physical model generated in the example case. FIGS. 25A and B describe the physical model regarding the component WT001. FIG. 25C describes the physical model regarding the component P001 and MV001. FIG. 25D describes the physical model regarding the component LS001.

### Second Example Embodiment

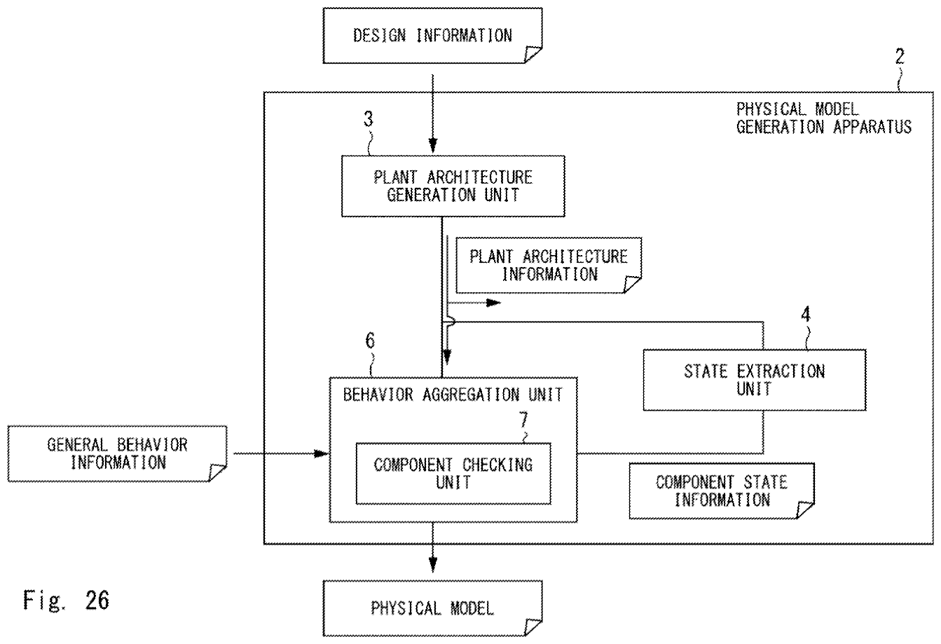

FIG. 26 illustrates a functional configuration of the 2nd example embodiment of the physical model generation apparatus 2. The physical model generation apparatus 2 according to this example embodiment supports the case where any general behavior for a type of a physical component is missing in the general behavior information. The physical model generation apparatus 2 includes a component checking unit 7 inside the behavior aggregation unit 6.

For each of the component items in the said plant architecture information, the component checking unit 7 gets the type from the said component item, and checks the general behavior information for the general behavior whose corresponding type is equal to the said type. If the said general behavior is missing in the general behavior information, the component checking unit 7 adds the said type to the list called MISSING_COMPONENT_LIST.

The component checking unit 7 sends the MISSING_COMPONENT_LIST to an output device such as a display (not shown in a figure) for requesting a user (e.g. plant operator) to enter the general behaviors of the types in the MISSING_COMPONENT_LIST, and persistently checks the general behavior information for the general behaviors of the types in the MISSING_COMPONENT_LIST.

When the user finishes entering the general behaviors of the types in the MISSING_COMPONENT_LIST to the general behavior information through an input device (not shown in a figure), and component checking unit 7 detects all the general behaviors of the types in the MISSING_COMPONENT_LIST are existing in the general behavior information; the component checking unit 7 informs the behavior aggregation unit 6 that the general behaviors of all the physical components in the said plant architecture information are present in the general behavior information.

### Example of Hardware Configuration

The hardware configuration of the physical model generation apparatus 2 of the 2nd example embodiment may be illustrated by FIG. 2, similarly to that of the physical model generation apparatus 2 of the 1st example embodiment. However, the storage device 1080 of the 2nd example embodiment stores the program that implements the functions of the physical model generation apparatus 2 of the 2nd example embodiment.

### Flow of Processes

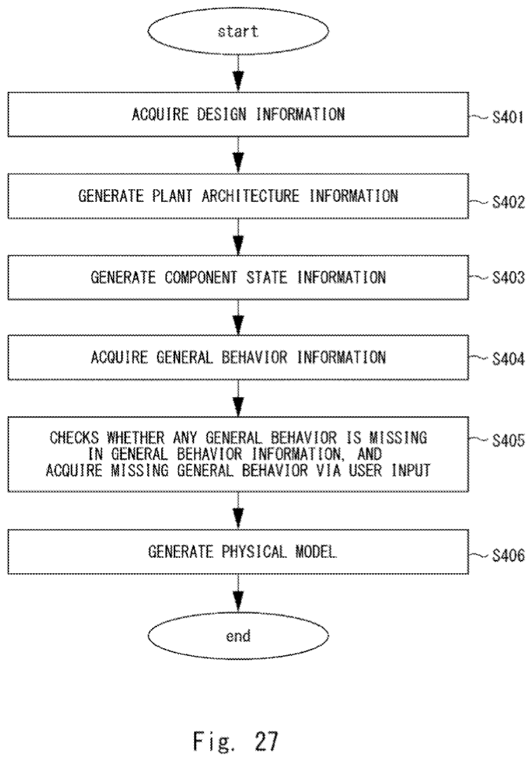

FIG. 27 is a flowchart illustrating the processes performed by the physical model generation apparatus 2 of the 2nd example embodiment. The plant architecture generation unit 3 acquires the design information (S401). The plant architecture generation unit 3 generates the plant architecture information based on the design information (S402). The state extraction unit 4 generates the component state information based on the plant architecture information (S403). The behavior aggregation unit 6 acquires the general behavior information (S404). The component checking unit 7 checks whether any general behavior is missing in the general behavior information, and acquires the missing general behavior via user input if there is any missing general behavior (S405) The behavior aggregation unit 6 generates the physical model based on the plant architecture information, the component state information, and the general behavior information (S406).

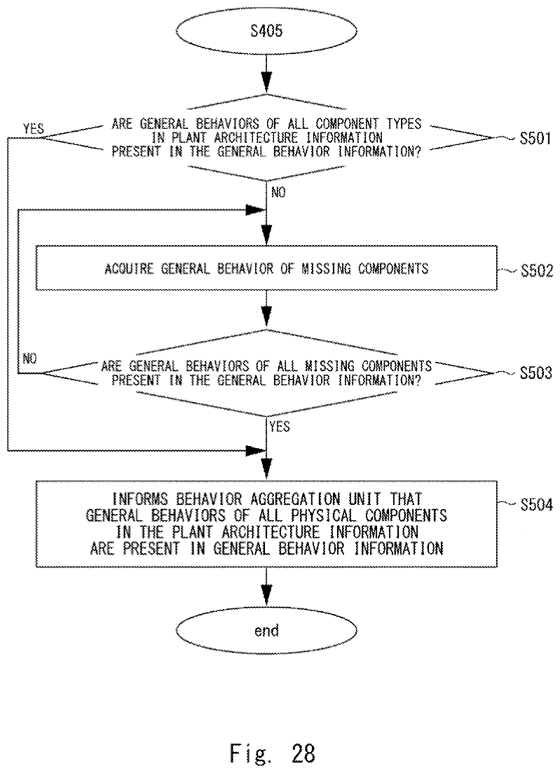

FIG. 28 is a flowchart illustrating an example working of the said step S405 in detail. The component checking unit 7 checks if the general behavior of all the component types in the plant architecture information are present in the general behavior information or not (S501). If yes, the S504 is executed.

The component checking unit 7 acquires the general behaviors of the said missing physical component types (S502). For example, the component checking unit 7 sends the list of missing physical component types to an output device for requesting the user to enter the general behaviors of the said missing physical component types.

The component checking unit 7 persistently checks for the general behaviors of the missing physical component types in the general behavior information (S503). If the component checking unit 7 does not find the general behaviors of all the missing physical component types, the step S504 is executed. On the other hand, if the component checking unit 7 finds a missing general behavior, the step S502 is executed again.

The component checking unit 7 informs the behavior aggregation unit 6 that general behaviors of all the physical components in the plant architecture information are present in the general behavior information (S504).

In the aforementioned embodiments, the program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been described above with reference to the embodiments, the present disclosure is not limited to the aforementioned description. Various changes that may be understood by one skilled in the art may be made on the configuration and the details of the present disclosure within the scope of the present disclosure.

Note that the present disclosure is not limited to the above-described example embodiments and can be modified as appropriate without departing from the scope and spirit of the disclosure.

### SUPPLEMENTARY NOTES

### Supplemental Note 1

A physical model generation apparatus comprising:

at least one processor; and

a memory storing instructions;

wherein the at least one processor is configured to execute the instructions to:
acquire design information of a target control system;
generate plant architecture information from the design information, the plant architecture information describing physical components and connections therebetween included in the target control system;
generate component state information that describes possible states for each physical component described in the plant architecture information;
acquire general behavior information that describes general behavior for each types of physical components; and
generate physical model of the target control system based on the plant architecture information, the component state information, and the general behavior information.

### Supplemental Note 2

The physical model generation apparatus according to Supplemental Note 1,

wherein the generation of the physical model includes:
extracting names of each physical component in the target control system from the plant architecture information;

extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

### Supplemental Note 3

The physical model generation apparatus according to Supplemental Note 1 or 2,

wherein the design information is an XML document in which a Piping Instrumentation Diagram of the target control system is described, and

the generation of the plant architecture information comprises to extract information about the physical components and the connections thereof from the XML document.

### Supplemental Note 4

The physical model generation apparatus according to any one of Supplemental Notes 1 to 3,

wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

### Supplemental Note 5

The physical model generation apparatus according to any one of Supplemental Notes 1 to 3,

wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

### Supplemental Note 6

The physical model generation apparatus according to any one of Supplemental Notes 1 to 5,

wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.

### Supplemental Note 7

A control method performed by a computer, comprising;

acquiring design information of a target control system;

generating plant architecture information from the design information, the plant architecture information describing physical components and connections therebetween included in the target control system;

generating component state information that describes possible states for each physical component described in the plant architecture information;

acquiring general behavior information that describes general behavior for each types of physical components; and

generating physical model of the target control system based on the plant architecture information, the component state information, and the general behavior information.

### Supplemental Note 8

The control method according to Supplemental Note 7,

wherein the generation of the physical model includes:
extracting names of each physical component in the target control system from the plant architecture information;
extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

### Supplemental Note 9

The control method according to Supplemental Note 7 or 8,

wherein the design information is an XML document in which a Piping Instrumentation Diagram of the target control system is described, and

the generation of the plant architecture information comprises to extract information about the physical components and the connections thereof from the XML document.

### Supplemental Note 10

The control method according to any one of Supplemental Notes 7 to 9,

wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

### Supplemental Note 11

The control method according to any one of Supplemental Notes 7 to 9,

wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

### Supplemental Note 12

The control method according to any one of Supplemental Notes 7 to 11,

wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.

### Supplemental Note 13

A non-transitory computer-readable storage medium storing a program that causes a computer to execute:

acquiring design information of a target control system;

generating plant architecture information from the design information, the plant architecture information describing physical components and connections therebetween included in the target control system;

generating component state information that describes possible states for each physical component described in the plant architecture information;

acquiring general behavior information that describes general behavior for each types of physical components; and

generating physical model of the target control system based on the plant architecture information, the component state information, and the general behavior information.

### Supplemental Note 14

The storage medium according to Supplemental Note 13,

wherein the generation of the physical model includes:
extracting names of each physical component in the target control system from the plant architecture information;
extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

### Supplemental Note 15

The storage medium according to Supplemental Note 13 or 14,

wherein the design information is an XML document in which a Piping Instrumentation Diagram of the target control system is described, and

the generation of the plant architecture information comprises to extract information about the physical components and the connections thereof from the XML document.

### Supplemental Note 16

The storage medium according to any one of Supplemental Notes 13 to 15,

wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

### Supplemental Note 17

The storage medium according to any one of Supplemental Notes 13 to 15,

wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

### Supplemental Note 18

The storage medium according to any one of Supplemental Notes 13 to 17,

wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.

### REFERENCE SIGNS LIST

2 physical model generation apparatus
3 plant architecture generation unit
4 state extraction unit
6 behavior aggregation unit
7 component checking unit
1000 computer
1020 bus
1040 processor
1060 memory
1080 storage device
1100 input/output interface
1120 network interface

What is claimed is:

1. A physical model generation apparatus comprising:
at least one processor; and
a memory storing instructions;
wherein the at least one processor is configured to execute the instructions to:
acquire design information of a target control system;
generate plant architecture information from the design information, the plant architecture information describing physical components and connections therebetween included in the target control system;
generate component state information that describes possible states for each physical component described in the plant architecture information;
acquire general behavior information that describes general behavior for each types of physical components; and
generate physical model of the target control system based on the plant architecture information, the component state information, and the general behavior information.

2. The physical model generation apparatus according to claim 1,
wherein the generation of the physical model includes:
extracting names of each physical component in the target control system from the plant architecture information;
extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

3. The physical model generation apparatus according to claim 1,
wherein the design information is an XML document in which a Piping Instrumentation Diagram of the target control system is described, and
the generation of the plant architecture information comprises to extract information about the physical components and the connections thereof from the XML document.

4. The physical model generation apparatus according to claim 1,
wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

5. The physical model generation apparatus according to claim 1,
wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

6. The physical model generation apparatus according to claim 1,
wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.

7. A control method performed by a computer, comprising;
acquiring design information of a target control system;
generating plant architecture information from the design information, the plant architecture information describing physical components and connections therebetween included in the target control system;
generating component state information that describes possible states for each physical component described in the plant architecture information;
acquiring general behavior information that describes general behavior for each types of physical components; and
generating physical model of the target control system based on the plant architecture information, the component state information, and the general behavior information.

8. The control method according to claim 7,
wherein the generation of the physical model includes:
extracting names of each physical component in the target control system from the plant architecture information;
extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

9. The control method according to claim 7,
wherein the design information is an XML document in which a Piping Instrumentation Diagram of the target control system is described, and
the generation of the plant architecture information comprises to extract information about the physical components and the connections thereof from the XML document.

10. The control method according to claim 7,
wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

11. The control method according to claim 7,
wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

12. The control method according to claim 7,
wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.

13. A non-transitory computer-readable storage medium storing a program that causes a computer to execute:
acquiring design information of a target control system;
generating plant architecture information from the design information, the plant architecture information describing physical components and connections therebetween included in the target control system;
generating component state information that describes possible states for each physical component described in the plant architecture information;
acquiring general behavior information that describes general behavior for each types of physical components; and
generating physical model of the target control system based on the plant architecture information, the component state information, and the general behavior information.

14. The storage medium according to claim 13,
wherein the generation of the physical model includes:
extracting names of each physical component in the target control system from the plant architecture information;
extracting states of each physical components in the target control system from the component state information;
converting the general behaviors described in the general behavior information into specific behaviors of each physical component in the target control system using the extracted names and states of each physical component in the target control system; and
generating the physical model that describes the specific behaviors of each physical component in the target control system.

15. The storage medium according to claim 13,
wherein the design information is an XML document in which a Piping Instrumentation Diagram of the target control system is described, and
the generation of the plant architecture information comprises to extract information about the physical components and the connections thereof from the XML document.

16. The storage medium according to claim 13,
wherein the generation of the component state information includes:
acquiring type state information that describes possible states for each type of the physical components;
for each physical component in the plant architecture information, acquiring possible states corresponding to the type of that physical component from the type state information; and
generating the component state information that describes the possible states acquired from the type state information.

17. The storage medium according to claim 13,
wherein the generation of the component state information includes:
acquiring a controller program that includes a logic for monitoring or controlling the physical components of the target control system;
extracting possible states of each physical component in the plant architecture information from the controller program; and
generating the component state information that describes the possible states extracted from the controller program.

18. The storage medium according to claim 13,
wherein the generation of the physical model includes:
for each type of the physical components in the plant architecture information, determining whether there is a corresponding general behavior to that type of the physical components in the general behavior information; and
for each type of the physical components to which there is no corresponding general behavior in the general behavior information, acquiring a user input that specifies the general behavior corresponding to that type of the physical component.
